(19) United States
(12) Patent Application Publication
(10) Pub. No.: US 2010/0309155 A1
(43) Pub. Date: Dec. 9, 2010

(54) TWO-DIMENSIONAL INPUT DEVICE, CONTROL DEVICE AND INTERACTIVE GAME SYSTEM

(75) Inventors: Chih-Hung LU, Hsinchu (TW); Cho-Yi Lin, Hsinchu (TW)

Correspondence Address: LanWay IPR Services, P.O. Box 220746, Chantilly, VA, 20153, US

(73) Assignee: PixArt Imaging Inc.

(21) Appl. No.: 12/758,785

(22) Filed: Apr. 12, 2010

(30) Foreign Application Priority Data
Jun. 8, 2009 (TW) 098119057

(51) Int. Cl. G06F 3/041

(52) U.S. Cl. 345/173

(57) ABSTRACT

A two-dimensional input device, control device and interactive game system are provided. The control device is suitable for communicating with a game console which performs a game program. The control device includes a two-dimensional input device and a remote controller. The two-dimensional input device outputs a two-dimensional coordinate data when being touched. The remote controller receives the two-dimensional coordinate data by a first communication method and outputs the two-dimensional coordinate data by a second communication method. Wherein, the game console receives the two-dimensional coordinate data and performs it with the game program.

### CROSS-REFERENCE TO RELATED APPLICATIONS

This application is based upon and claims the benefit of priority from the prior Taiwanese Patent Application No. 098119057, filed Jun. 8, 2009, the entire contents of which are incorporated herein by reference.

### BACKGROUND

The present invention relates to a technology of the touch control field. More particularly, the present invention relates to a light joystick replaced by a plane input unit of a two-dimensional input device, a control device and an interactive game system. The pleasure of video games has started ever since its launches worldwide. Notwithstanding the thriving games create entertainment, they fail to bring interactions between people in real life. This is especially found in role-playing games which are implemented with enhanced 3D images yet without real interactions.

For this reason, Nintendo Inc. presents the all new 2^{nd} generation home-use game console, the Wii. The main idea of Wii is to bring true interactions between people in order that players will have on-site sensations. The Nintendo Wii console is mainly controlled via motion and acceleration by two controllers that acquire the speed, gesture, and etc. of the player. Nonetheless, the two controllers in utilization are usually controlled with motion and acceleration only, which make it difficult for games that are operated in a stationary manner.

### BRIEF SUMMARY

The present invention relates to a control device for disposing a two-dimensional input device and a remote controller to be a right joystick and light joystick. Therefore, the present invention can provide diversification real feeling with the specific game.

The present invention relates to a two-dimensional input device which can communicate with the game console directly. Therefore, the user can play the existing game program and the specific game.

In one aspect of the present invention, a control device is provided. The control device is suitable for communicating with a game console which performing a game program. The control device comprises a two-dimensional input device and a remote controller. The two-dimensional input device generates a two-dimensional coordinate data when being touched and outputs the two-dimensional coordinate data. The remote controller receives the two-dimensional coordinate data by a first communication method and outputs the two-dimensional coordinate data to the game console by a second communication method. Wherein, the game console receives the two-dimensional coordinate data and performs a game program according to the two-dimensional coordinate data.

In an embodiment of the present invention, the two-dimensional input device further comprises a touch panel, a touch sense module, a first microprocessor and a first connection module. The touch panel appears from the two-dimensional input device for providing user to touch. The touch sense module is coupled to the touch panel for generating a sense signal according to touching of the touch panel and outputting the sense signal. The first microprocessor is coupled to the touch sense module for performing a coordinate operation when receiving the sense signal to generate a two-dimensional coordinate data and output the two-dimensional coordinate data. The first connection module is coupled to the first microprocessor for receiving the two-dimensional coordinate data and outputting the two-dimensional coordinate data to the remote controller by the first communication method.

In an embodiment of the present invention, the first connection module can be replaced with a third communication module for communicating with a remote controller by a wireless transmission method.

In another aspect of the present invention, an interactive game system is provided. The interactive game system comprises a game console, a display and a control device. The game console performs a game program. The display is coupled to the game console for displaying a display frame corresponding to the game program. The control device comprises a two-dimensional input device and a remote controller. Wherein, the two-dimensional input device generates a two-dimensional coordinate data when being touched and outputs the two-dimensional coordinate data. The remote controller receives the two-dimensional coordinate data by a first communication method and outputs the two-dimensional coordinate data to the game console by a second communication method. Wherein, the game console receives the two-dimensional coordinate data for performing the game program.

In another aspect of the present invention, the two-dimensional input device is suitable for communicating with a game console. The game console performs a game program. The two-dimensional input device comprises a touch panel, a touch sense module, an operation module, an acceleration sensor, an optical image processing circuit and a core circuit. The touch panel appears from the two-dimensional input device for providing user to touch. The touch sense module is coupled to the touch panel for generating a sense signal according to touching of the touch panel and outputting the sense signal. The operation module generates an operation instruction according to operation of user and outputs the operation instruction. The acceleration sensor generates an acceleration data according to motion of the remote controller and outputs the acceleration data. The optical image processing circuit captures light emitted by the illuminant emitting module for performing filter and image processing to obtain a motion data and outputs the motion data. The core circuit is coupled to the touch sense module, the optical image processing circuit, the operation module and the acceleration sensor for receiving the sense signal, the operation instruction, the acceleration data and the motion data, performing a coordinate operation with the sense signal to obtain a two-dimensional coordinate data and outputting the two-dimensional coordinate data, the operation instruction, the acceleration data and the motion data to the game console by a communication method.

In another aspect of the present invention, an interactive game system is provided. The interactive game system comprises a game console, display and a two-dimensional input device. The game console performs a game program. The display is coupled to the game console for displaying a display frame corresponding to the game program. The two-dimensional input device generates a two-dimensional coordinate data when being touched and outputs the two-dimensional coordinate data. Wherein, the game console receives the two-dimensional coordinate data for performing the game program.

In the present invention, the two-dimensional input device is disposed in the control device so that user can input data interacting with the game program on the two-dimensional input device. Therefore, user can have diversification selection of the game program. Besides, the two-dimensional input device can communicate with the game console alone so that operation complex can be reduced for playing more game programs.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of an interactive game system of an embodiment of the present invention.

FIG. 2 is a schematic circuit block diagram of a two-dimensional input device and a remote controller of an embodiment of the present invention.

FIG. 3 is a schematic circuit block diagram of a two-dimensional input device and a remote controller of another embodiment of the present invention.

FIG. 4 is a schematic diagram of an interactive game system of another embodiment of the present invention.

FIG. 5 is a schematic circuit block diagram of a two-dimensional input device and a remote controller of FIG. 4 of the present invention.

FIG. 6 is a schematic diagram of the two-dimensional input device applying with optical sense of an embodiment of the present invention.

FIG. 7 is a schematic diagram of the two-dimensional input device applying with optical sense of another embodiment of the present invention.

FIG. 8 is a schematic diagram of the two-dimensional input device applying with optical sense of other embodiment of the present invention.

FIG. 9 is a schematic diagram of the two-dimensional input device applying with resistive sense of other embodiment of the present invention.

FIG. 10 is a schematic diagram of the two-dimensional input device applying with capacitance sense of other embodiment of the present invention.

FIG. 11 is a schematic diagram of the two-dimensional input device applying with surface acoustic wave sense of other embodiment of the present invention.

### DETAILED DESCRIPTION

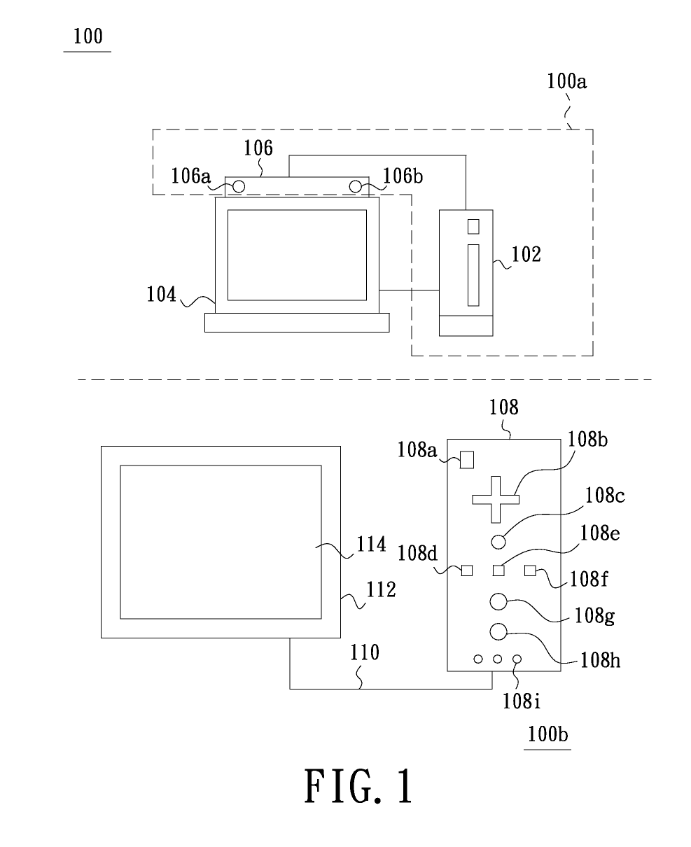

Please refer to FIG. 1 which is a schematic diagram of an interactive game system of an embodiment of the present invention. The interactive game system 100 comprises a main game device 100a, a control device 100b, and a display 104, wherein the main game device 100a comprises a game console 102 and an illuminant emitting module 106. The control device 100b comprises a remote controller 108, a cable 110 and a two-dimensional input device 112.

In the embodiment, the game console 102 is coupled to the display 104 and the illuminant emitting module 106. The game console 102 can be inputted a game disc, inserted a memory card or memory disc. The game program can be burned or stored to a programmable memory of the game console 102. The game console 102 performs the game program after being enabled and outputs a display frame of the game program to the display 104. Besides, the game console 102 also outputs a light emitting signal to the illuminant emitting module 106 after being enabled. Wherein, one of ordinary skill person in the art may know that the game console 102 can be WII game console. The present invention, however, is not limited thereto.

The display 104 receives and displays the display frame of the game program. The illuminant emitting module 106 has at least an illuminant. In the present invention, the illuminants are two and labeled as 106a and 106b, but the illuminant amount is decided by a request of design. The present invention, however, is not limited thereto. The illuminants 106a and 106b are enabled to emit light when the illuminant emitting module 106 receives the illuminant emitting signal.

The illuminants 106a, 106b are enabled by the illuminant emitting module 106 after receiving the illuminant emitting signal. Wherein, light emitted by the illuminants 106a, 106b can be infrared ray. The present invention, however, is not limited thereto. The remote controller 108 has a plurality of operation keys 108a, 108b, 108c, 108d, 108e, 108f, 108g, 108h and an indicator light 108i. The operation key 108a can be a power switch which can enable the remote controller 108 after being pressed; contrariwise, the remote controller 108 cab be disabled when the operation key 108a is pressed again. The operation key 108b is a crisscross key for providing direction selection to user. Besides, the operation key 108b also can be a circle key or four independent operation keys indicating different directions respectively. The present invention, however, is not limited thereto. The operation keys 108c, 108g and 108h can have their corresponding function and be a selection key, a menu key and a start key respectively. The indicator light 108i is used to indicate status of the remote controller 108. For example, each indicator light 108i indicates a serial number corresponding to the game console 102 if there are several remote controllers 108.

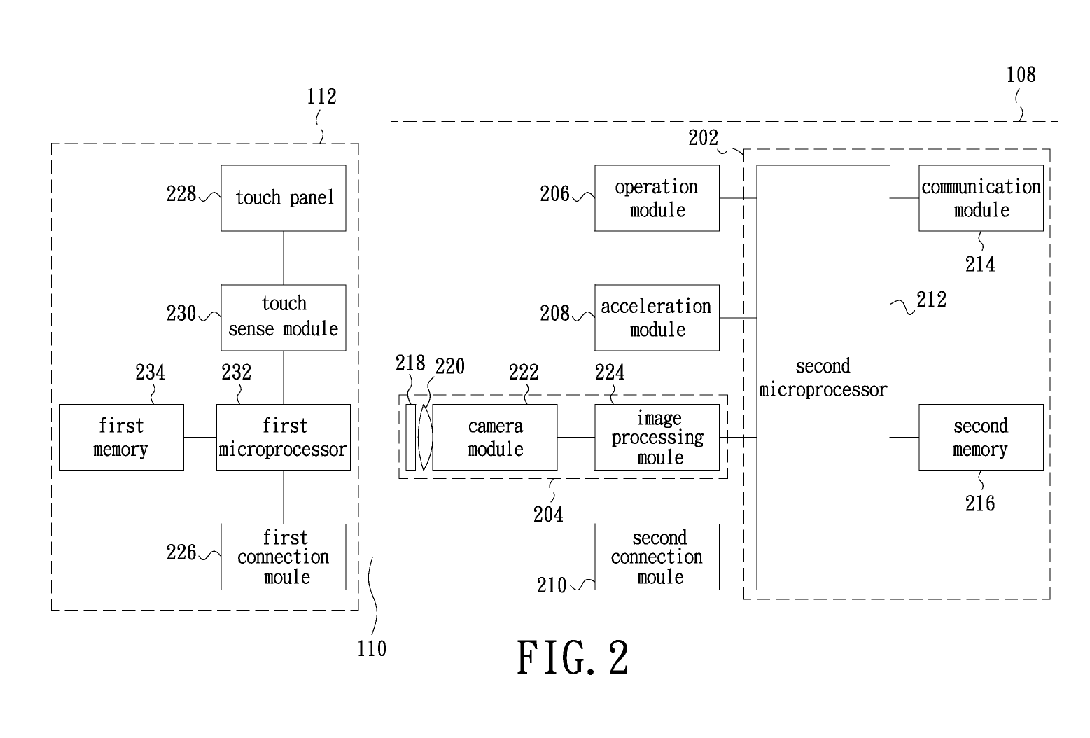

Please refer to FIG. 2 which is a schematic circuit block diagram of a two-dimensional input device and a remote controller of an embodiment of the present invention. In FIG. 2, the two-dimensional input device 112 comprises a touch panel 228, a touch sense module 230, a first microprocessor 232, a first memory 234 and a first connection module 226. The first connection module 226 is transmitted with the remote controller 108 by physical cable communication method. Wherein, the touch panel 228 is same as the touch panel 114 on FIG. 1. Wherein, one of ordinary skill person in the art may know that the touch panel 114 can be a touch panel of resistive, capacitance, optical or surface acoustic wave. The present invention, however, is not limited thereto

The touch panel 228 is appeared from the two-dimensional input device 112 for providing user to touch. In other words, the touch panel 228 has a surface appeared from the two-dimensional input device 112 for touching of user.

The first memory 234 stores program of operation of the first microprocessor 232 and the two-dimensional coordinate data temporarily.

The touch sense module 230 is coupled to the touch panel 228. When the touch panel 228 is touched, the touch sense module 230 generates a sense signal and outputs the sense signal to the first microprocessor 232.

The first microprocessor 232 receives the sense signal and performs a coordinate operation with the sense signal to obtain a two-dimensional coordinate data. Then, the first microprocessor 232 outputs the two-dimensional coordinate data to the first connection module 226. In this design, the two-dimensional coordinate data is used to perform a function instruction data or present position coordinate data.

In another way of the present invention, the first microprocessor 232 performs the coordinate operation with the sense signal according to a coordinate design of the touch panel 228 to obtain the two-dimensional coordinate data. Then, the first microprocessor 232 outputs the two-dimensional coordinate data to the first connection module 226. In this design, the game console 102 in FIG. 1 computes a data corresponding to a frame of the game program with the two-dimensional coordinate data after the game console 102 receives the two-dimensional coordinate data and performs the data.

The first connection module 226 is coupled to the first microprocessor 232 for receiving the two-dimensional coordinate data and transmitting is to the remote controller 108 by physical cable 110.

Please refer to FIG. 2, the remote controller 108 comprises a core circuit 202, an optical image processing circuit 204, an operation module 206, an acceleration sensor 208, and a second connection module 210. Wherein, the second connection module 210 is connected to the first connection module 226 of the two-dimensional input device 112 for receiving the two-dimensional coordinate data.

The operation module 206 generates an operation instruction according to operation of user and outputs the operation instruction the core circuit 202. The operation module 206 comprises operation keys 108a, 108b, 108c, 108d, 108e, 108f, 108g and 108h of FIG. 1.

The acceleration sensor 208 generates an acceleration data according to motion of the remote controller 108 and outputs the acceleration data to the core circuit 202. Wherein, the acceleration sensor 208 is a sensor which is used to detect acceleration or deceleration of three-axis of the remote controller 108.

The optical image processing circuit 204 captures light emitted by the illuminant emitting module 106 of FIG. 1 for obtaining a motion data of the remote controller 108 and outputting the motion data to the core circuit 202. The optical image processing circuit 204 comprises an infrared ray filter 218, a lens 220, a camera module 222 and an image processing module 224. Wherein, the infrared ray filter 218 filters an outside light when the outside light (comprising light emitted by the illuminant emitting module 106 of FIG. 1) surrounding the infrared ray filter 218 pass the infrared ray filter 218 and only lets the infrared ray to pass. The lens 220 is located behind the infrared ray filter 218 for collecting the infrared ray passing the infrared ray filter 218 and outputting the infrared ray to the camera module 222.

In the embodiment, the camera module 222 is located behind the lens 220 for capturing the infrared ray to obtain an image. Then, the camera module 222 outputs the image to the image processing module 224. The image processing module 224 is coupled to the camera module 222 and the core circuit 202 for recognizing a point having high luminance of the image and performing a motion operation with the point to obtain a motion data and output the motion data to the core circuit 202.

The core circuit 202 comprises a second microprocessor 212, a communication module 214 and a second memory 216. Wherein, the second microprocessor 212 is coupled to the second connection module 210, the image processing module 224, the operation module 206, the acceleration sensor 208, the communication module 214, and the second memory 216.

The second microprocessor 212 receives the two-dimensional coordinate data, the operation instruction, the acceleration data and the motion data respectively and determines position of the remote controller 108 according to the acceleration data and the motion data. Besides, the second microprocessor 212 transmits the determined present position data of the remote controller 108, the two-dimensional coordinate data, and the operation instruction to the communication module 214.

The communication module 214 can communicate with the game console 102 of FIG. 1 by wire or wireless. If communicating by wire, the communication module 214 receives the determined present position data of the remote controller 108, the two-dimensional coordinate data and the operation instruction and transmits the determined present position data of the remote controller 108, the two-dimensional coordinate data and the operation instruction to the game console 102 by physical cable (not shown) for performing. Reversely, if communicating by wireless, the communication module 214 receives the determined present position data of the remote controller 108, the two-dimensional coordinate data and the operation instruction and transmits the determined present position data of the remote controller 108, the two-dimensional coordinate data and the operation instruction to the game console 102 through antenna (not shown) after wireless signal transference.

Wherein, one of ordinary skill in the art should know that the communication method between the remote controller 108 and the game console 102 of FIG. 1 can be Bluetooth or RF (radio frequency). The present invention, however, is not limited thereto.

Wherein, the second memory 216 can store the determined present position data of the remote controller 108, the two-dimensional coordinate data and the operation instruction temporarily.

Therefore, the touch sense module 230 generates a sense signal and outputs the sense signal to the first microprocessor 232 after user of the control device 100b inputs data on the two-dimensional input device 112 (i.e. the above touch panel 228 is touched). The first microprocessor 232 receives the sense signal for performing a coordinate operation to obtain the two-dimensional coordinate data. Then, the first microprocessor 232 outputs the two-dimensional coordinate data to the second connection module 210 through the first connection module 226. Secondly, the second microprocessor 212 receives the two-dimensional coordinate data and transmits the two-dimensional coordinate data to the communication module 214 after processing. The communication module 214 transmits data inputted by user to the game console 102.

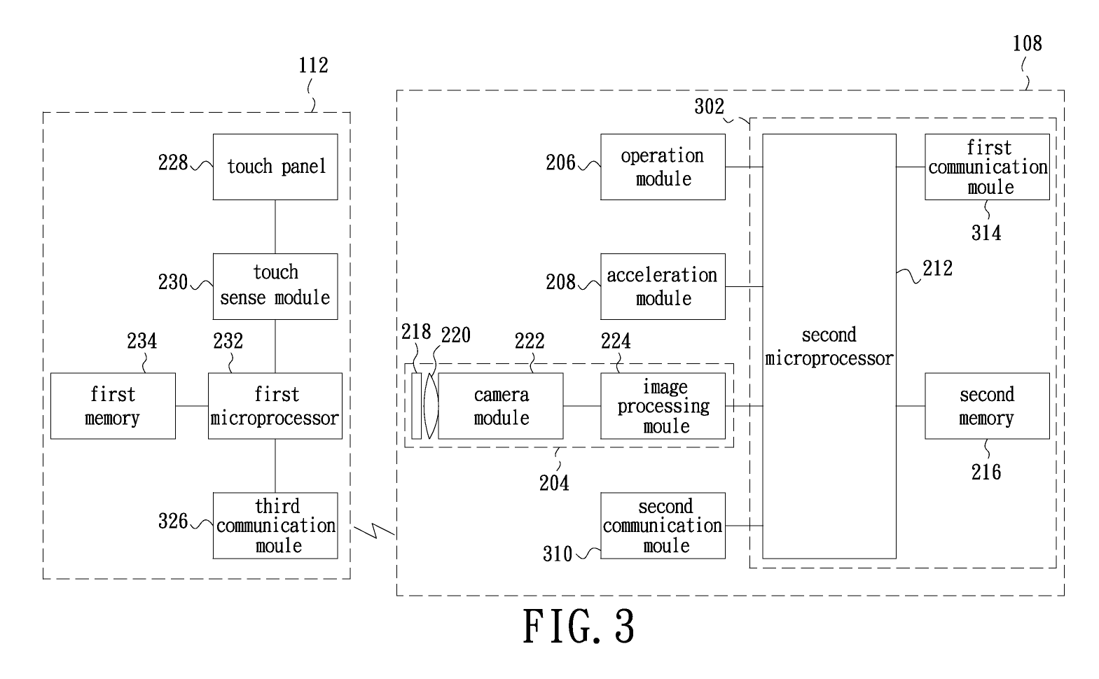

Please refer to FIG. 3, it is a schematic circuit block diagram of a two-dimensional input device and a remote controller of another embodiment of the present invention. In this embodiment, the same elements with FIG. 2's are not described here for easily describing. The different between FIG. 2 and FIG. 3 is that the two-dimensional input device 112 communicates with the remote controller 108 by wireless communication method. Therefore, a third communication module 326 is disposed in the two-dimensional input device 112 and a second communication module 310 is disposed in the remote controller 108.

As description of the two-dimensional input device 112 above, the first microprocessor 232 outputs the two-dimensional coordinate data to the third communication module 326. The third communication module 326 outputs the two-dimensional coordinate data to the second communication module 310 through the antenna (not shown) after transferring it into a wireless signal. The second communication module 310 transfers the two-dimensional coordinate data into a signal which can be operated by the second microprocessor 212 and outputs the signal to the second microprocessor 212 after receiving the wireless signal with the two-dimensional coordinate data through the antenna (not shown).

In the embodiment of the present invention, the wireless communication method between the second communication module 310 and the third communication module 326 can be Bluetooth or RF (radio frequency). The present invention, however, is not limited thereto.

In this embodiment, operations of the first communication module 314 of FIG. 3 and the communication module 214 of FIG. 2 are the same and no more description here.

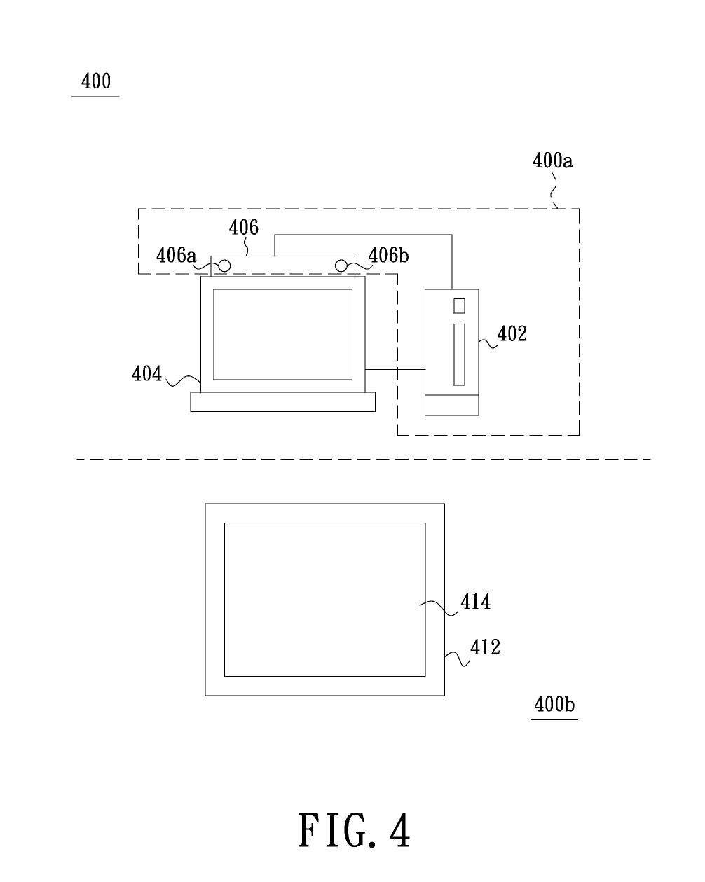

Please refer to FIG. 4, it is a schematic diagram of an interactive game system of another embodiment of the present invention. In FIG. 4, the interactive game system 400 comprises a main game device 400a, a control device 400b, and a display 404. Wherein, the main game device 400a comprises a game console 402 and an illuminant emitting module 406, the control device 400b comprises a two-dimensional input device 412.

In this embodiment, the game console 402 and the game console 102 of FIG. 1 are the same and no more description here. Besides, the display 404 and the illuminant emitting module 406 and the display 104 and the illuminant emitting module 106 of FIG. 1 are respectively the same and no more description here.

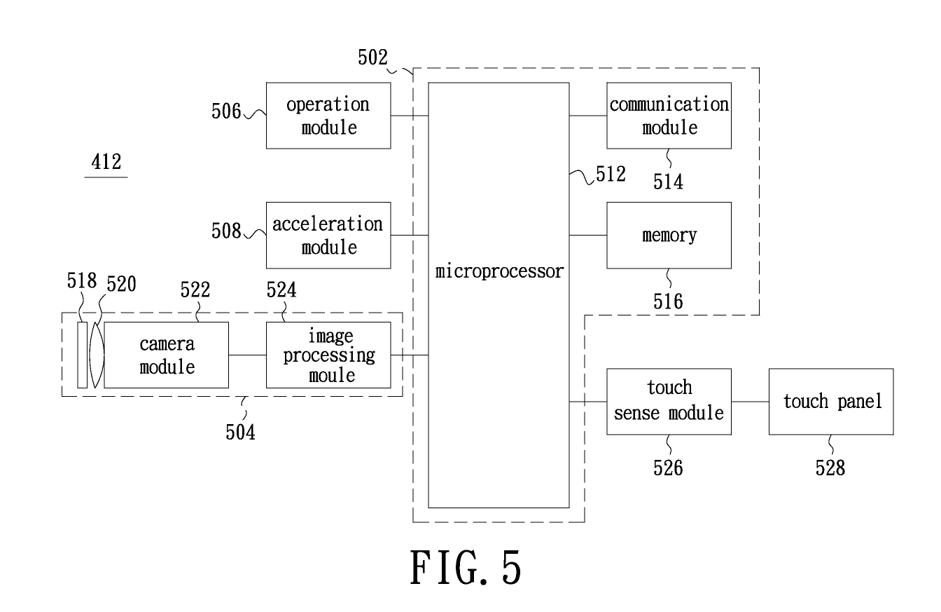

Please refer to FIG. 5, it is a schematic circuit block diagram of a two-dimensional input device and a remote controller of FIG. 4 of the present invention. In FIG. 5, the two-dimensional input device 412 comprises a core circuit 502, an optical image processing circuit 504, an operation module 506, an acceleration sensor 508, a touch panel 528, and a touch sense module 526. Besides, the core circuit 502 comprises a microprocessor 512, a communication module 514 and a memory 516. Wherein, the panel 528 is equal to the touch panel 414 of FIG. 4. Wherein, one of ordinary skill in the art should know that the touch panel 414 can be a panel of resistive, capacitance, optical and surface acoustic wave. The present invention, however, is not limited thereto.

The touch panel 528 is appeared from the two-dimensional input device 412 for providing touch to user. In other words, the touch panel 528 has a surface appeared from the two-dimensional input device 412 so that the user can touch the surface.

The touch sense module 526 is coupled to the touch panel 528. The touch sense module 526 generates a sense signal and outputs the sense signal to the microprocessor 512 when the touch panel 528 is touched.

The microprocessor 512 receives the sense signal for performing a coordinate operation with the sense signal to obtain a two-dimensional coordinate data. Then, the microprocessor 512 outputs the two-dimensional coordinate data to the communication module 514. In this design, the two-dimensional coordinate data is used to perform a function instruction data or present position coordinate data.

In another way of the present invention, the microprocessor 512 performs the coordinate operation with the sense signal according to a coordinate design of the touch panel 528 to obtain the two-dimensional coordinate data. Then, the microprocessor 512 outputs the two-dimensional coordinate data to the communication module 514. In this design, the game console 402 in FIG. 4 computes a data corresponding to a frame of the game program with the two-dimensional coordinate data after the game console 402 receives the two-dimensional coordinate data and performs the data.

In the present embodiment, operation keys 108a, 108b, 108c, 108d, 108e, 108f, 108g and 108h of FIG. 1 are disposed on the operation module 506 of the two-dimensional input device 412 for generating an operation instruction according to touch of user and outputting the operation instruction to the microprocessor 512.

Besides, in the present embodiment, the operation module 506 can be abbreviated and the touch panel 528 is disposed patterns similar the operation keys of FIG. 1 for providing touch of user. Therefore, hardware operation keys are not needed to be disposed and only a pattern printed with operation keys disposed on the touch panel 528 so that the pattern is touch control.

The acceleration sensor 508 generates an acceleration data according to motion of the two-dimensional input device 412 and outputs the acceleration data to the microprocessor 512. Wherein, the acceleration sensor 508 is a sensor which used to detect acceleration or deceleration of three-axis of the two-dimensional input device 412.

The optical image processing circuit 504 captures light emitted by the illuminant emitting module 406 of FIG. 4 for obtaining a motion data of the two-dimensional input device 412 and outputting the motion data to the microprocessor 512. The optical image processing circuit 504 comprises an infrared ray filter 518, a lens 520, a camera module 522 and an image processing module 524. Wherein, the infrared ray filter 518 filters an outside light when the outside light (comprising light emitted by the illuminant emitting module 406 of FIG. 4) surrounding the infrared ray filter 518 pass the infrared ray filter 518 and only lets the infrared ray to pass. The lens 520 is located behind the infrared ray filter for collecting the infrared ray passing the infrared ray filter 518 and outputting the infrared ray to the camera module 522.

In the embodiment, the camera module 522 is located behind the lens 520 for capturing the infrared ray to obtain an image. Then, the camera module 522 outputs the image to the image processing module 524. The image processing module 524 is coupled to the camera module 522 and the microprocessor 512 for recognizing a point having high luminance of the image and performing a motion operation with the point to obtain a motion data and output the motion data to the core circuit 502.

In the present invention, the microprocessor 512 is coupled to the image processing module 524, the operation module 506, the acceleration sensor 508, the communication module 514 and the memory 516.

The microprocessor 512 receives the sense signal, the operation instruction, the acceleration data and the motion data respectively and determines position of the two-dimensional input device 412 according to the acceleration data and the motion data. Wherein, the microprocessor 512 also performs a coordinate operation with the sense signal to obtain the two-dimensional coordinate data. Besides, the microprocessor 512 transmits the determined present position data of the two-dimensional input device 412, the two-dimensional coordinate data and the operation instruction to the communication module 514.

The communication module 514 can communicate with the game console 402 of FIG. 4 by wire or wireless. If communicating by wire, the communication module 514 receives the determined present position data of the two-dimensional input device 412, the two-dimensional coordinate data and the operation instruction and transmits the determined present position data of the two-dimensional input device 412, the two-dimensional coordinate data and the operation instruction to the game console 402 by physical cable (not shown) for performing. Reversely, if communicating by wireless, the communication module 514 receives the determined present position data of the two-dimensional input device 412, the two-dimensional coordinate data and the operation instruction and transmits the determined present position data of the two-dimensional input device 412, the two-dimensional coordinate data and the operation instruction to the game console 402 through antenna (not shown) after wireless signal transference.

Wherein, one of ordinary skill in the art should know that the communication method between the two-dimensional input device 412 and the game console 402 of FIG. 4 can be Bluetooth or RF (radio frequency). The present invention, however, is not limited thereto.

Wherein, the second memory 516 can store the determined present position data of the two-dimensional input device 412, the two-dimensional coordinate data and the operation instruction temporarily.

Therefore, the touch sense module 530 generates a sense signal according to a touch defined by user of the control device 400b inputs data on the two-dimensional input device 412 (i.e. the above touch panel 528 is touched) and outputs the sense signal to the microprocessor 512. The microprocessor 512 receives the sense signal for performing a coordinate operation to obtain the two-dimensional coordinate data. Then, the microprocessor 512 outputs the two-dimensional coordinate data to the communication module 514 after processing. Secondly, the microprocessor 512 receives the two-dimensional coordinate data and transmits the two-dimensional coordinate data to the communication module 514 after processing. The communication module 514 transmits data inputted by user to the game console 402.

In a prefer embodiment of the present invention, the touch panel 114 and 414 can be multitouch or single touch for user at the same time. In the other words, user can use one finger or a plurality of fingers to control the two-dimensional input device 112 and 412. The two-dimensional input device 112 and 412 which cab be composed by a panel of resistive, capacitance, optical and surface acoustic wave are described below.

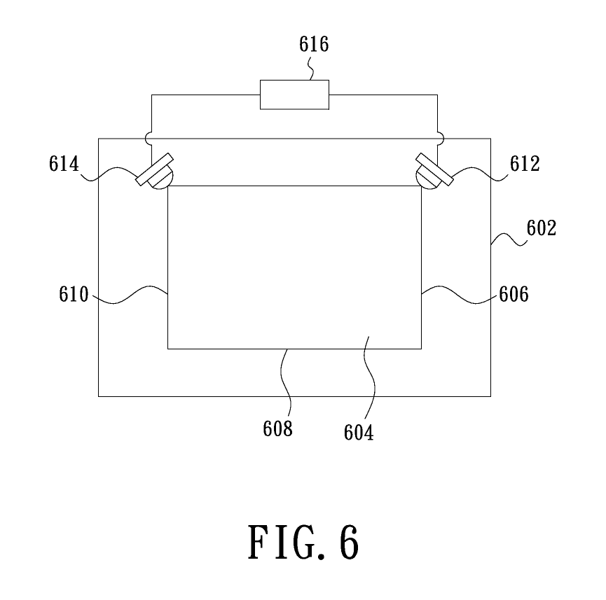

Please refer to FIG. 6, it is a schematic diagram of the two-dimensional input device applying with optical sense of an embodiment of the present invention. The two-dimensional input device 602 comprises a touch control area 604, photosensors 614,612 and a processing circuit 616. The photosensors 614 and 612 are coupled to the processing circuit 616 respectively. Wherein, a shape of the touch control area 604 is a rectangle. Three sides of the touch control area 604 are disposed with the retro-reflectors 606, 608 and 610. A range sensed by the photosensor 614 is a reflection area formed by the retro-reflectors 606 and 608 and a range sensed by the photosensor 612 is a reflection area formed by the retro-reflectors 608 and 610. Therefore, when the touch control area 604 is touched, the photosensors 614 and 612 transmit images to the processing circuit 616 which is similar to the first microprocessor 232 of FIG. 2 and the microprocessor 512 of FIG. 5 for processing to obtain a coordinate position of the touch point with a triangle computing method. Wherein, for example, the triangle computing method for obtaining the coordinate position of the touch point can be a computing method disclosed in U.S. Pat. No. 4,782,328, 4,504,557 and 6803906.

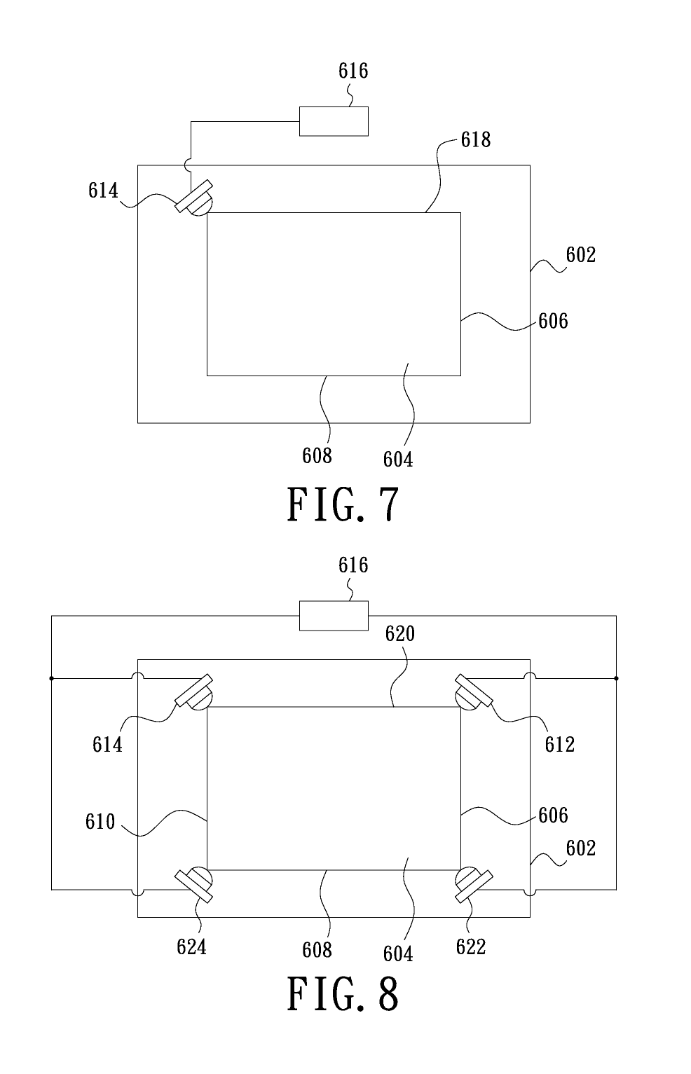

Now, please refer FIG. 7, it is a schematic diagram of the two-dimensional input device applying with optical sense of another embodiment of the present invention. The two-dimensional input device 602 comprises a touch control area 604, a photosensor 614 and a processing circuit 616. Wherein, a shape of the touch control area 604 is a rectangle. Three sides of the touch control area 604 are disposed with retro-reflectors 606, 608 and 618 and the retro-reflector 908 can be a plane mirror. The present invention, however, is not limited thereto.

In FIG. 7, when the touch control area 604 is touched, the photosensors 614 and 612 transmit images to the processing circuit 616 which is similar to the first microprocessor 232 of FIG. 2 and the microprocessor 512 of FIG. 5 for processing to obtain a coordinate position of the touch point. The computing method of FIG. 7 can be the computing method disclosed in R.O.C. Application Number 098100969 filed on Jan. 12, 2009.

Please refer FIG. 8 hereinbelow, it is a schematic diagram of the two-dimensional input device applying with optical sense of other embodiment of the present invention. The two-dimensional input device 602 comprises a touch control area 604, photosensors 612,614,622,624 and a processing circuit 616. The photosensors 612,614,622,624 are coupled to the processing circuit 616 respectively. Wherein, a shape of the touch control area 604 is a rectangle. Four sides of the touch control area 604 are disposed with the retro-reflectors 606, 608, 610 and 620. In FIG. 8, when the touch control area 604 is touched, the photosensors 614 and 612 transmit images to the processing circuit 616 which is similar to the first microprocessor 232 of FIG. 2 and the microprocessor 512 of FIG. 5 for processing to obtain a coordinate position of the touch point. The computing method of FIG. 8 can be the computing method disclosed in R.O.C. Application Number 097143217 filed on Nov. 7, 2008.

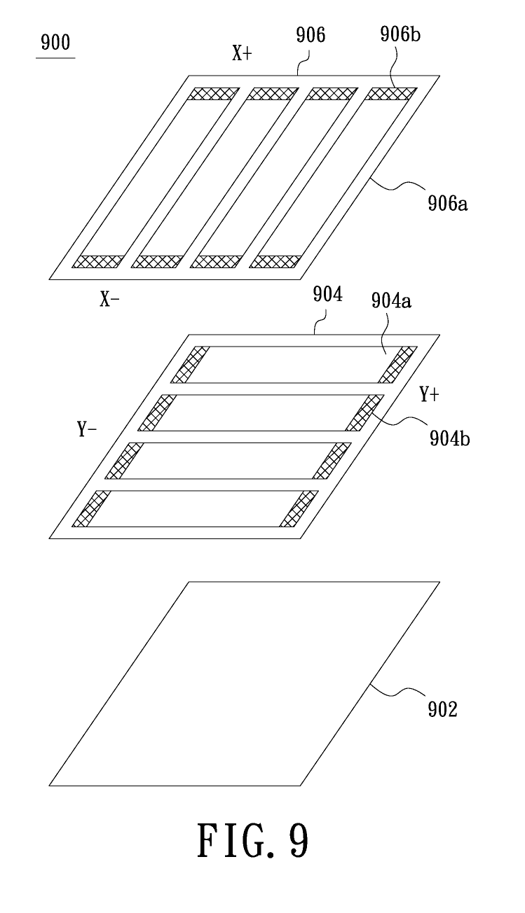

Please refer FIG. 9, it is a schematic diagram of the two-dimensional input device applying with resistive sense of other embodiment of the present invention. The touch panel 900 of the two-dimensional input device comprises an insulation thin film 902, a substratum through thin film 904 and a superstratum through thin film 906, wherein the substratum through thin film 904 is disposed between the insulation thin film 902 and the superstratum through thin film 906. A plurality of Y axis through resistor detect patterns 904a are disposed on a top surface of the substratum through thin film 904, and a plurality of X axis through resistor detect patterns 906a are disposed on an under surface of the superstratum through thin film 906. Wherein, lines of each Y axis through resistor detect pattern 904a are arranged parallel, and lines of each X axis through resistor detect pattern 906a are also arranged parallel. Therefore, lines of each Y axis through resistor detect pattern 904a and lines of each X axis through resistor detect pattern 906a are formed as perpendicular rows and columns. Besides, the Y axis electrodes 904b are disposed at two terminals of lines of the Y axis through resistor detect pattern 904a, and the X axis electrodes 906b are disposed at two terminals of lines of the X axis through resistor detect pattern 906a. After the two-dimensional input device is enabled, the Y axis electrodes 904ba and the X axis electrodes 906b are supplied with voltages continuously and changes of the voltages are detected periodically.

In FIG. 9, when the superstratum through thin film 906 is touched, i.e. the touch sense module 230 of FIG. 2 receives the sense signal and transmits the sense signal to the first microprocessor 232 of FIG. 2 for processing to obtain a coordinate position of the touch point. The computing method of FIG. 9 can be the computing method disclosed in R.O.C. Public Number 200915165.

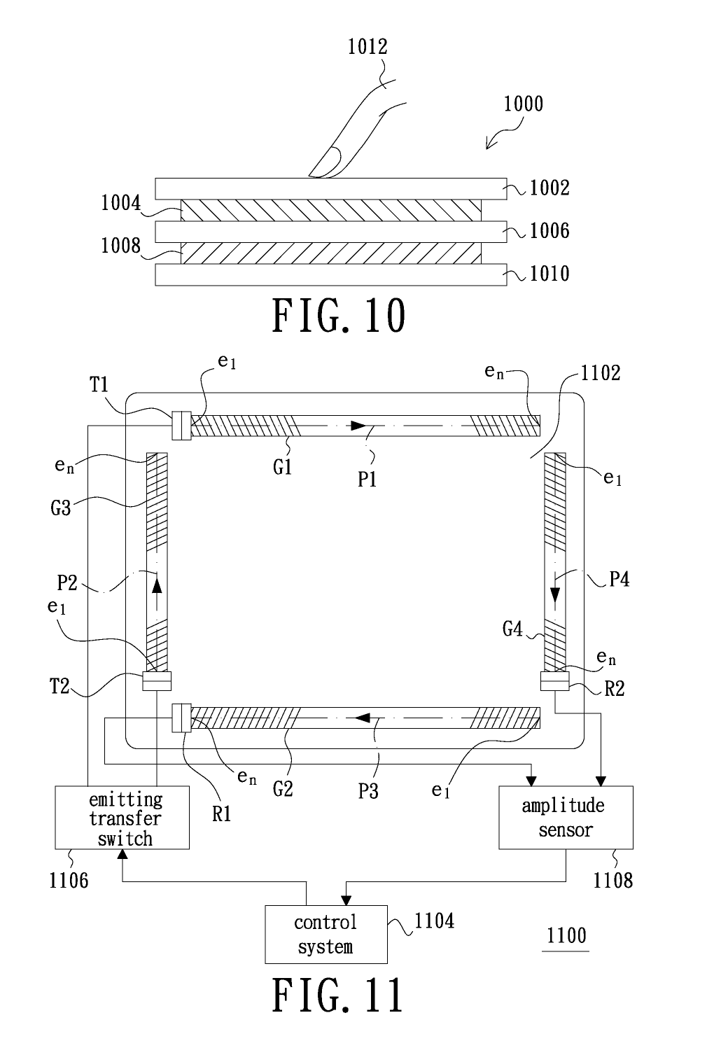

Please refer FIG. 10, it is a schematic diagram of the two-dimensional input device applying with capacitance sense of other embodiment of the present invention. The touch panel 1000 of the two-dimensional input device from top to bottom comprises a panel 1002, a Y axis sense layer 1004, an isolation layer 1006, a X axis sense layer 1008 and a bedplate 1010. When the finger 1012 touches the panel 1002, a sense quantity (capacitance) of the touched point will be changed so that the touch sense module 230 (as shown in FIG. 2) connected to the touch control plate 1000 receives a sense signal of capacitance change for transmitting the sense signal to the first microprocessor 232 of FIG. 2 to obtain a coordinate position of the touch point after processing (the capacitance is transferred into sense quantity, for example, it is represented that the touch control plate 1000 is touched when the sense quantity is larger than a predetermined threshold value; otherwise, it is represented that touch of the touch control plate 1000 is finish or there is no object existing on the touch control plate 1000). The computing method of FIG. 10 can be the computing method disclosed in R.O.C. Patent Number 1269997.

Please refer FIG. 11, it is a schematic diagram of the two-dimensional input device applying with surface acoustic wave sense of other embodiment of the present invention. The two-dimensional input device 1100 comprises a base plate 1102, a control system 1104, a transducer switch 1106 and an amplifier and detector 1108, wherein the transducer switch 1106 and the amplifier and detector 1108 are coupled to the control system 1104. The control system 1104 can be the touch sense module 230 or the first microprocessor 232 of FIG. 2.

A couple of the transmitter transducer T1, T2 and a couple of the receiver transducers R1, R2 are disposed on the base plate 1102 for connecting the control system 1104. Each transducer (T1, T2, R1 and R2) has reflective gratings G1, G2, G3 and G4 composed of a plurality of reflective elements (e1 to en) disposed along paths P1, P2, P3 and P4. The control system 1104 generates a transmission signal through the transducer switch 1106 for transmitting the transmission signal to the respondent transmitter transducer T1, T2 respectively so that the transmitter transducer T1, T2 can generate a surface acoustic wave for propagating along paths P1, P2. Secondly, the receiver transducers R1, R2 transfer the received surface acoustic wave energy into signals for outputting to the amplifier and detector 1108. The computing method of FIG. 11 can be the computing method disclosed in U.S. Pat. No. 4,644,100.

Accordingly, the two-dimensional input device and the control device thereof in the present invention, user can input data interacting with the game program on the two-dimensional input device. Therefore, user can have diversification selection of the game program. Besides, the two-dimensional input device can communicate with the game console alone so that operation complex can be reduced and play more game programs.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A control device suitable for communicating with a game console which performs a game program, the control device comprising:
a two-dimensional input device for generating a two-dimensional coordinate data when being touched and outputting the two-dimensional coordinate data; and
a remote controller for receiving the two-dimensional coordinate data by a first communication method and outputting the two-dimensional coordinate data to the game console by a second communication method;
wherein, the game console receives the two-dimensional coordinate data and performs the game program according to the two-dimensional coordinate data.

2. The control device of claim 1, wherein the two-dimensional input device comprises:
a touch panel appeared from the two-dimensional input device for providing user to touch;
a touch sense module coupled to the touch panel for generating a sense signal according to touching of the touch panel and outputting the sense signal;
a first microprocessor coupled to the touch sense module for performing a coordinate operation with the sense signal when receiving the sense signal to generate the two-dimensional coordinate data and output the two-dimensional coordinate data; and
a first connection module coupled to the first microprocessor for receiving the two-dimensional coordinate data and outputting the two-dimensional coordinate data to the remote controller by the first communication method;
wherein the first communication method is a transmission communication method of physical cable.

3. The control device of claim 1, wherein the two-dimensional input device comprises:
a touch panel appeared from the two-dimensional input device for providing user to touch;
a touch sense module coupled to the touch panel for generating a sense signal according to touching of the touch panel and outputting the sense signal;
a first microprocessor coupled to the touch sense module for performing a coordinate operation with the sense signal when receiving the sense signal to generate the two-dimensional coordinate data and output the two-dimensional coordinate data; and
a third communication module coupled to the first microprocessor for receiving the two-dimensional coordinate data and outputting the two-dimensional coordinate data to the remote controller by the first communication method;
wherein the first communication method is a wireless transmission communication method and the third communication module transfers the two-dimensional coordinate data into a wireless signal with the two-dimensional coordinate data for outputting.

4. The control device of claim 1, wherein the game console is coupled to an illuminant emitting module and the illuminant emitting module emits light after being enabled.

5. The control device of claim 4, wherein the remote controller comprises:
an operation module for generating an operation instruction according to operation of the user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second connection module for receiving the two-dimensional coordinate data by the first communication method and outputting the two-dimensional coordinate data; and
a core circuit coupled to the second connection module, the optical image processing circuit, the operation module and the acceleration sensor for receiving the two-dimensional coordinate data, the operation instruction, the acceleration data and the motion data and outputting the two-dimensional coordinate data, the operation instruction, the acceleration data and the motion data to the game console by the second communication method;
wherein the first communication method is a transmission communication method of physical cable.

6. The control device of claim 5, wherein the core circuit comprises:
a second microprocessor coupled to the second connection module, the optical image processing circuit, the operation module and the acceleration sensor for receiving and outputting the two-dimensional coordinate data, the operation instruction, the acceleration data and the motion data;
a communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

7. The control device of claim 6, wherein the optical image processing circuit comprises:
an infrared ray filter for filtering outside light having light from the illuminant emitting module and guiding at least an infrared ray to pass the infrared ray filter;
a lens for collecting and outputting the infrared ray;
a camera module for capturing an image transmitted from the lens and outputting the image; and
an image processing module coupled to the camera module and the second microprocessor for receiving the image, performing a motion operation with the image and outputting the motion data to the second microprocessor.

8. The control device of claim 4, wherein the remote controller comprises:
an operation module for generating an operation instruction according to operation of the user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second communication module for receiving the two-dimensional coordinate data by the first communication method and outputting the two-dimensional coordinate data; and
a core circuit coupled to the second communication module, the optical image processing circuit, the operation module and the acceleration sensor for receiving the two-dimensional coordinate data, the operation instruction, the acceleration data and the motion data and outputting the two-dimensional coordinate data, the operation instruction, the acceleration data and the motion data to the game console by the second communication method;
wherein the first communication method is a wireless transmission communication method and the second communication module receives a wireless signal having the two-dimensional coordinate data.

9. The control device of claim 8, wherein the core circuit comprises:
a second microprocessor coupled to the second communication module, the optical image processing circuit, the operation module and the acceleration sensor for receiving and outputting the two-dimensional coordinate data, the operation instruction, the acceleration data and the motion data;
a first communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

10. The control device of claim 9, wherein the optical image processing circuit comprises:
an infrared ray filter for filtering outside light having light from the illuminant emitting module and guiding at least an infrared ray to pass the infrared ray filter;
a lens for collecting and outputting the infrared ray;
a camera module for capturing an image transmitted from the lens and outputting the image; and
an image processing module coupled to the camera module and the second microprocessor for receiving the image, performing a motion operation with the image and outputting the motion data to the second microprocessor.

11. The control device of claim 1, wherein the second communication method is a transmission communication method of physical cable or a wireless communication method.

12. The control device of claim 1, wherein the touch panel is a panel of resistive, capacitance, optical and surface acoustic wave.

13. A two-dimensional input device suitable for communicating with a game console which performs a game program, the two-dimensional input device comprising:
a touch panel appeared from the two-dimensional input device for providing user to touch;
a touch sense module coupled to the touch panel for generating a sense signal according to touching of the touch panel and outputting the sense signal;
an operation module for generating an operation instruction according to operation of the user and outputting the operation instruction;
an acceleration sensor for generating an acceleration data according to motion of the remote controller and outputting the acceleration data;
an optical image processing circuit for capturing light emitted by an illuminant emitting module to obtain a motion data and output the motion data; and
a core circuit coupled to the touch sense module, the optical image processing circuit, the operation module and the acceleration sensor for receiving the sense signal, the operation instruction, the acceleration data and the motion data, performing a coordinate operation with the sense signal to obtain a two-dimensional coordinate data and outputting the two-dimensional coordinate data, the operation instruction, the acceleration data and the motion data to the game console by a communication method.

14. The two-dimensional input device of claim 13, wherein the core circuit comprises:
a microprocessor coupled to the touch sense module, the optical image processing circuit, the operation module and the acceleration sensor for performing a coordinate operation with the sense signal to obtain the two-dimensional coordinate data and outputting the two-dimensional coordinate data, the operation instruction, the acceleration data and the motion data;
a communication module coupled to the microprocessor for receiving the two-dimensional coordinate data, the operation instruction, the acceleration data and the motion data and outputting the two-dimensional coordinate data, the operation instruction, the acceleration data and the motion data to the game console with the communication method; and
a memory coupled to the microprocessor for storing the two-dimensional coordinate data, the operation instruction, the acceleration data and the motion data temporarily.

15. The two-dimensional input device of claim 14, wherein the optical image processing circuit comprises:
an infrared ray filter for filtering outside light and guiding at least an infrared ray to pass the infrared ray filter;
a lens for collecting and outputting the infrared ray;
a camera module for capturing an image transmitted from the lens and outputting the image; and
an image processing module coupled to the camera module and the microprocessor for receiving the image, performing a motion operation with the image and outputting the motion data to the second microprocessor.

16. The two-dimensional input device of claim 13, wherein the communication method is a transmission communication method of physical cable or wireless transmission communication method.

17. The two-dimensional input device of claim 13, wherein the touch panel is a panel of resistive, capacitance, optical and surface acoustic wave.

18. An interactive game system comprising:
a game console for performing a game program;
a display coupled to the game console for displaying a display frame corresponding to the game program; and
a two-dimensional input device for generating a two-dimensional coordinate data when being touched and outputting the two-dimensional coordinate data;
wherein, the game console receives the two-dimensional coordinate data for performing the game program.

19. The interactive game system of claim 18, wherein the two-dimensional input device comprises:
a touch panel appeared from the two-dimensional input device for providing user to touch;
a touch sense module coupled to the touch panel for generating and outputting the sense signal when being touched;
an operation module for generating an operation instruction according to operation of user and outputting the operation instruction;
an acceleration sensor for generating an acceleration data according to motion of the remote controller and outputting the acceleration data;
an optical image processing circuit for capturing light emitted by an illuminant emitting module to obtain a motion data and output the motion data; and
a core circuit coupled to the touch sense module, the optical image processing circuit, the operation module and the acceleration sensor for receiving the sense signal, the operation instruction, the acceleration data and the motion data, performing a coordinate operation with the sense signal to obtain the two-dimensional coordinate data, and outputting the two-dimensional coordinate data, the operation instruction, the acceleration data and the motion data to the game console.

20. The interactive game system of claim 18, further comprises a remote controller communicated with the two-dimensional input device for receiving the two-dimensional coordinate data by a first communication method and outputting the two-dimensional coordinate data to the game console by a second communication method.

21. The interactive game system of claim 20, wherein the two-dimensional input device comprises:
a touch panel appeared from the two-dimensional input device for providing user to touch;
a touch sense module coupled to the touch panel for generating a sense signal according to touching of the touch panel and outputting the sense signal;
a first microprocessor coupled to the touch sense module for performing a coordinate operation when receiving the sense signal to generate the two-dimensional coordinate data and output the two-dimensional coordinate data; and
a connection module coupled to the first microprocessor for receiving the two-dimensional coordinate data and outputting the two-dimensional coordinate data to the remote controller by the first communication method.

22. The interactive game system of claim 21, further comprising an illuminant emitting module coupled to the game console and the illuminant emitting module emits light after being enabled.

23. The interactive game system of claim 22, wherein the remote controller comprises:
an operation module for generating an operation instruction according to operation of the user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second communication module for receiving the two-dimensional coordinate data by the first communication method and outputting the two-dimensional coordinate data; and
a core circuit coupled to the second connection module, the optical image processing circuit, the operation module and the acceleration sensor for receiving the two-dimensional coordinate data, the operation instruction, the acceleration data and the motion data and outputting the two-dimensional coordinate data, the operation instruction, the acceleration data and the motion data to the game console by the second communication method.
